(19) United States
(12) Patent Application Publication
(10) Pub. No.: US 2026/0328671 A1
(43) Pub. Date: Oct. 22, 2026

(54) OBSERVATION DEVICE AND OBSERVATION METHOD

(71) Applicant: HAMAMATSU PHOTONICS K.K., Hamamatsu-shi, Shizuoka (JP)

(72) Inventors: Yuki FUJIMORI, Hamamatsu-shi, Shizuoka (JP); Osamu YASUHIKO, Hamamatsu-shi, Shizuoka (JP); Hidenao YAMADA, Hamamatsu-shi, Shizuoka (JP)

(73) Assignee: HAMAMATSU PHOTONICS K.K., Hamamatsu-shi, Shizuoka (JP)

(21) Appl. No.: 19/122,021

(22) PCT Filed: Sep. 11, 2023
(86) PCT No.: PCT/JP2023/033051

§ 371 Date: Apr. 17, 2025

(30) Foreign Application Priority Data
Oct. 26, 2022 (JP) 2022-171221

(51) Int. Cl. G01N 15/1434; G01N 15/1429

(52) U.S. Cl. CPC G01N 15/1434; G01N 15/1429

(57) ABSTRACT

An observation apparatus includes a light source, a splitting unit, a combining unit, a first modulation unit, a second modulation unit, an imaging unit, and a processing unit. The first modulation unit inputs first split light, modulates the first split light at each of a plurality of modulation frequencies, and outputs the first split light after the frequency modulation. Lenses irradiate an observation object along an irradiation direction according to the modulation frequency with the first split light modulated by the first modulation unit. The imaging unit includes a plurality of pixels arranged in a direction intersecting with a moving direction of an image of the observation object by the first split light on an imaging plane on which the image of the observation object S is formed. The imaging unit receives combined light, and repeatedly outputs a detection signal representing a one-dimensional interference image.

### TECHNICAL FIELD

The present disclosure relates to an apparatus and a method for observing a moving observation object.

### BACKGROUND ART

Patent Document 1 discloses an invention of an apparatus and a method for observing a moving observation object. The observation apparatus described in this document splits light output from a light source into first split light and second split light, combines the first split light which is Doppler shifted by being passed through the moving observation object and the second split light obtained by shifting an optical frequency by a heterodyne frequency, and performs heterodyne interference between the first split light and the second split light.

Further, the observation apparatus can acquire time series data of a complex amplitude image of the first split light on an imaging plane based on time series data of an intensity image (two-dimensional interference image) of interference light arriving at the imaging plane of a camera. The above observation apparatus can perform non-staining and non-invasive imaging of the moving observation object, and may be used for, for example, observing a moving cell in a flow cytometer.

### CITATION LIST

### Patent Literature

Patent Document 1: International Publication No. 2013/065796

### Non Patent Literature

Non Patent Document 1: W. Choi, C. Fang-Yen, K. Badizadegan, S. Oh, N. Lue, R. R. Dasari, and M. S. Feld, “Tomographic phase microscopy”, Nature Methods, Vol. 4, No. 9, pp. 717-719, 2007
Non Patent Document 2: Y. Sung, W. Choi, C. Fang-Yen, K. Badizadegan, R. R. Dasari, and M. S. Feld, “Optical diffraction tomography for high resolution live cell imaging”, Optics Express, Vol.17, No. 1, pp. 266-277, 2009

### SUMMARY OF INVENTION

### Technical Problem

When the case in which the invention disclosed in Patent Document 1 is applied to the flow cytometer is considered, the camera used for acquiring the intensity image of the interference light needs to be an area camera in which a plurality of pixels are arranged two-dimensionally (for example, 1280×800) on an imaging plane and having a high frame rate (for example, 25 kfps). The camera described above is very expensive, and therefore, the observation apparatus also becomes expensive.

Further, in the invention disclosed in Patent Document 1, an optical system from the observation object to the camera has a special configuration, and thus, adjustment of the optical system is not easy, and further, observation of the observation object is also not easy.

An object of an embodiment is to provide an apparatus and a method capable of easily observing a moving observation object with an inexpensive configuration.

### Solution to Problem

An embodiment is an observation apparatus. The observation apparatus is an apparatus for observing a moving observation object, and includes (1) a light source for outputting light; (2) a splitting unit for splitting the light into first split light and second split light; (3) a first modulation unit for modulating the first split light at each of a plurality of modulation frequencies different from each other; (4) an irradiation unit for irradiating the observation object along an irradiation direction according to the modulation frequency with the first split light modulated by the first modulation unit; (5) a combining unit for combining the first split light passed through the observation object and the second split light to output combined light; (6) an imaging unit including a plurality of pixels arranged in a direction intersecting with a moving direction of an image of the observation object on an imaging plane on which the image of the observation object is formed, and for receiving the combined light by the plurality of pixels, and repeatedly outputting a detection signal representing a one-dimensional interference image; and (7) a processing unit for generating a complex amplitude image for each of a plurality of irradiation directions on the observation object corresponding to the plurality of modulation frequencies based on time series data of the one-dimensional interference image generated from the detection signal repeatedly output from the imaging unit, and generating a three-dimensional refractive index distribution image of the observation object based on the complex amplitude image of each of the plurality of irradiation directions.

An embodiment is an observation method. The observation method is a method for observing a moving observation object, and includes (1) a splitting step of splitting light output from a light source into first split light and second split light by using a splitting unit; (2) a first modulation step of modulating the first split light at each of a plurality of modulation frequencies different from each other by using a first modulation unit; (3) an irradiation step of irradiating the observation object along an irradiation direction according to the modulation frequency with the first split light modulated by the first modulation unit; (4) a combining step of combining the first split light passed through the observation object and the second split light to output combined light by using a combining unit; (5) an imaging step of using an imaging unit including a plurality of pixels arranged in a direction intersecting with a moving direction of an image of the observation object on an imaging plane on which the image of the observation object is formed, receiving the combined light by the plurality of pixels, and repeatedly outputting a detection signal representing a one-dimensional interference image; and (6) a processing step of generating a complex amplitude image for each of a plurality of irradiation directions on the observation object corresponding to the plurality of modulation frequencies based on time series data of the one-dimensional interference image generated from the detection signal repeatedly output from the imaging unit, and generating a three-dimensional refractive index distribution image of the observation object based on the complex amplitude image of each of the plurality of irradiation directions.

### Advantageous Effects of Invention

According to the observation apparatus and the observation method of the embodiments, a moving observation object can be easily observed with an inexpensive configuration.

### BRIEF DESCRIPTION OF DRAWINGS

FIG. 1 is a diagram illustrating a configuration of an observation apparatus 1.

FIG. 2 is a diagram illustrating a point image of first split light for each modulation frequency On formed on a front focal plane (a Pl plane) of a lens 33.

FIG. 3 is a diagram for describing irradiation of the first split light on an observation object S by the lens 33.

FIG. 4 is a diagram illustrating a configuration of an observation apparatus 1A.

FIG. 5 is a diagram illustrating a configuration of an observation apparatus 1B.

FIG. 6 is a diagram illustrating a configuration of an observation apparatus 1C.

FIG. 7 is a diagram illustrating a configuration of a first modulation unit 21A and a surrounding optical system.

FIG. 8 is a diagram illustrating a configuration of the first modulation unit 21A and the surrounding optical system.

FIG. 9 includes diagrams for describing a diffraction grating which is recorded on a plate-shaped member of the first modulation unit 21A, and illustrates (a) a diagram illustrating a modulation distribution of each of diffraction gratings having a plurality of spatial frequency components kₙ (kₘᵢₙ to kₘₐₓ), and (b) a diagram illustrating a modulation distribution after the diffraction gratings having the plurality of spatial frequency components are superimposed.

FIG. 10 includes (a) a diagram illustrating a configuration of a first modulation unit 21B and a surrounding optical system, and (b) a diagram illustrating a modulation frequency in each region on a modulation plane of a spatial light modulator of the first modulation unit 21B by grayscale.

FIG. 11 includes (a) a diagram illustrating a configuration of a first modulation unit 21C and a surrounding optical system, and (b) a diagram illustrating a modulation frequency in each region on a modulation plane of a spatial light modulator of the first modulation unit 21C by grayscale.

FIG. 12 includes (a) a diagram illustrating a configuration of a first modulation unit 21D and a surrounding optical system, (b) a diagram illustrating an intensity modulation amount in each region on a modulation plane of a spatial light modulator of the first modulation unit 21D by grayscale, and (c) a graph showing the intensity modulation amount in each region along a y direction on the modulation plane of the spatial light modulator of the first modulation unit 21D.

FIG. 13 is a diagram illustrating a modification of a configuration around an imaging unit 23.

### DESCRIPTION OF EMBODIMENTS

Hereinafter, embodiments of an observation apparatus and an observation method will be described in detail with reference to the accompanying drawings. In the description of the drawings, the same elements will be denoted by the same reference signs, and redundant description will be omitted. The present invention is not limited to these examples, and the Claims, their equivalents, and all the changes within the scope are intended as would fall within the scope of the present invention.

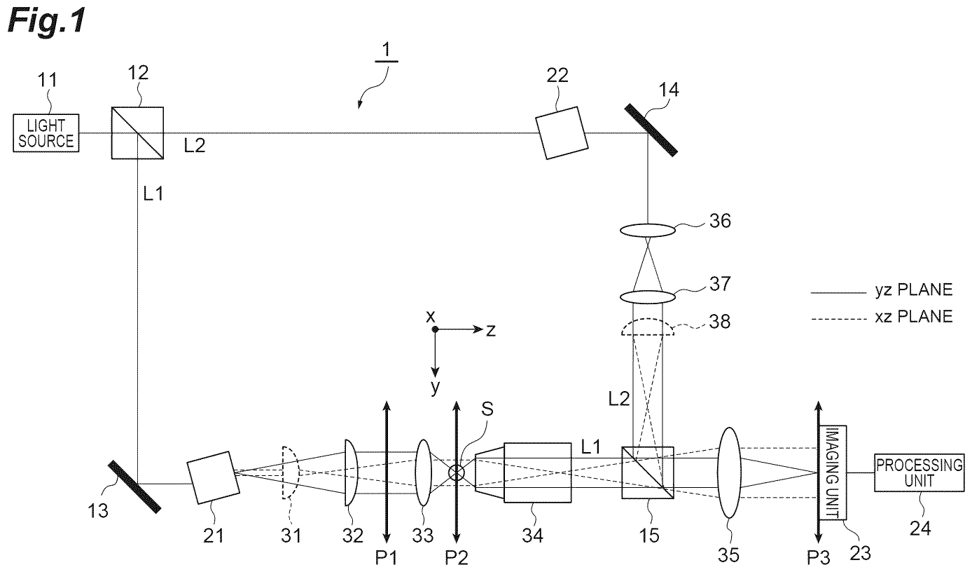

FIG. 1 is a diagram illustrating a configuration of an observation apparatus 1. The observation apparatus 1 is an apparatus for observing a moving observation object S, and includes a light source 11, a splitting unit 12, a combining unit 15, a first modulation unit 21, a second modulation unit 22, an imaging unit 23, and a processing unit 24. Further, an observation method performed by using the observation apparatus 1 includes a splitting step, a combining step, a first modulation step, a second modulation step, an imaging step, and a processing step.

The light source 11 outputs light. The light source 11 is preferably a laser light source for outputting laser light having a single optical frequency ω₀. The light source 11 is, for example, a He—Ne laser light source.

The splitting unit 12 is an optical system which is optically coupled to the light source 11. The splitting unit 12 inputs the light output from the light source 11, and splits the light into two light beams of first split light L1 and second split light L2 (the splitting step). The splitting unit 12 outputs the first split light L1 to a mirror 13, and outputs the second split light L2 to the second modulation unit 22. The splitting unit 12 is a beam splitter, and may be a half mirror.

The mirror 13 is optically coupled to the splitting unit 12. The mirror 13 inputs the first split light L1 output from the splitting unit 12, reflects the first split light L1, and outputs the reflected light to the first modulation unit 21. The mirror 14 is optically coupled to the second modulation unit 22. The mirror 14 inputs the second split light L2 output from the splitting unit 12 and passed through the second modulation unit 22, reflects the second split light L2, and outputs the reflected light to a lens 36.

The combining unit 15 is an optical system which inputs the first split light L1 which is reflected by the mirror 13 and passed through the first modulation unit 21, the observation object S, and the like, and inputs the second split light L2 which is reflected by the mirror 14 and passed through the lens 36 and the like. The combining unit 15 combines the first split light L1 and second split light L2 input to the unit, and outputs combined light to a lens 35 (the combining step). The combining unit 15 is a beam splitter, and may be a half mirror.

The imaging unit 23 receives the combined light output from the combining unit 15 and passed through the lens 35, and outputs a detection signal representing an interference image of the first split light L1 and the second split light L2 to the processing unit 24 (the imaging step). The processing unit 24 generates a three-dimensional refractive index distribution image of the observation object S based on the detection signal repeatedly output from the imaging unit 23 (the processing step).

The optical system from the splitting unit 12 to the combining unit 15 via the mirrors 13 and 14 constitutes a Mach-Zehnder interferometer. The observation object S moves in a path intersecting with the optical path of the first split light L1 from the mirror 13 to the combining unit 15.

The observation object S is, for example, cells which are aligned in a line and move in a flow path of the flow cytometer having a cross section size of 250×250 μm² at an average speed of 20 mm/s. In the following description, an xyz orthogonal coordinate system is set, a moving direction of the observation object S is set as a y direction, a direction parallel to an optical axis of a lens 34 provided at a subsequent stage of the observation object S is set as a z direction, and a direction orthogonal to both the y direction and the z direction described above is set as an x direction.

The first modulation unit 21, a lens 31, a lens 32, and a lens 33 are arranged in sequence on the optical path of the first split light L1 from the mirror 13 to the observation object S. The lens 34 is arranged on the optical path of the first split light L1 from the observation object S to the combining unit 15. The second modulation unit 22, the lens 36, a lens 37, and a lens 38 are arranged in sequence on the optical path of the second split light L2 from the splitting unit 12 to the combining unit 15 via the mirror 14. The lens 35 is arranged on the optical path of the combined light from the combining unit 15 to the imaging unit 23.

The first modulation unit 21 inputs the first split light L1 arriving from the mirror 13, modulates the first split light L1 at each of a plurality of modulation frequencies different from each other, and outputs the first split light L1 after the frequency modulation (the first modulation step).

The first modulation unit 21 may have a configuration including an acousto-optic element for frequency modulating the light by Bragg diffraction. In this case, in the first modulation unit 21, by applying an RF signal including a plurality of frequency components different from each other to the acousto-optic element, and causing the first split light L1 to be incident on the acousto-optic element, the first split light L1 can be modulated at the modulation frequency corresponding to each frequency component of the RF signal.

In the case in which a wavelength of the first split light L1 is set to 2, a velocity of an acoustic wave in the acousto-optic element is set to Va, and an n-th frequency component out of the N frequency components Ω₁ to Ω_{N} of the RF signal is set to Ωₙ, a diffraction angle On of the first split light L1 which is modulated at the frequency Ωₙ is represented by the following Formula (1). The first modulation unit 21 can output the first split light L1 of an optical frequency ω₀+Ωₙ which is modulated at the frequency Ωₙ in a direction of the diffraction angle θₙ. That is, the first modulation unit 21 can output the first split light L1 which is modulated by each of the N frequency components Ω₁ to Ω_{N} in directions different from each other.

### [Formula 1]

sin θₙ=±λΩₙ/Vα (1)

For example, diffracted light having a positive diffraction order (diffracted light output in the same direction as a propagation direction of the acoustic wave) is set to be used. A moving speed Vs of the observation object S is set to 20 mm/s, an optical resolution Ay is set to 0.2 μm, and a band width BW is set to 100 kHz (=Vs/Δy). An interval of the modulation frequency is set to 100 kHz, it is set to N=100, and it is set to Ωₙ=(195+0.1 n) MHz. That is, the minimum modulation frequency Ω₁ is set to 195.1 MHz, and the maximum modulation frequency Ω_{N} is set to 205.0 MHZ.

The lenses 31 to 33 are provided as an optical system constituting an irradiation unit, and irradiate the observation object S along an irradiation direction according to the modulation frequency Ωₙ with the first split light L1 which is modulated by the first modulation unit 21 (the irradiation step). Each of the lens 31 and the lens 32 is a cylindrical lens. The lens 33 is a spherical lens.

In this diagram, a light beam of the first split light L1 in the yz plane (in the plane of paper) is indicated by a solid line, and further, a light beam of the first split light L1 in the xz plane (in a plane perpendicular to the plane of paper) is indicated by a dashed line. The same applies to the second split light L2, and further, the same applies to the subsequent diagrams. Further, a lens shape of the cylindrical lens illustrated by a dashed line indicates a lens shape in the xz plane (in the plane perpendicular to the plane of paper).

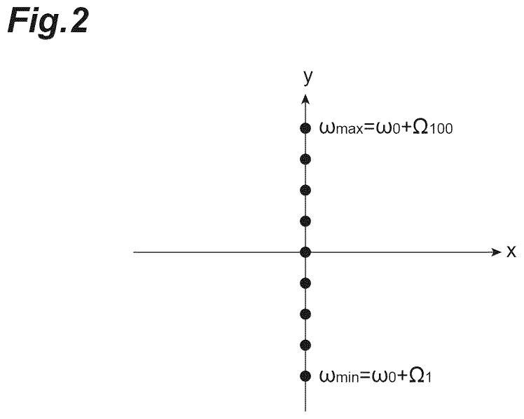

The lens 32 forms a point image of the first split light L1 for each modulation frequency Ωₙ at a discrete position along the y direction on a front focal plane (a P1 plane) of the lens 33. A rear focal plane (a P2 plane) of the lens 33 is a plane including a moving path of the observation object S. FIG. 2 is a diagram illustrating the point image of the first split light for each modulation frequency Ωₙ which is formed on the front focal plane (the P1 plane) of the lens 33. Each of the point images is indicated by a black circle.

The P1 plane is a Fourier plane of the P2 plane, and thus, the horizontal axis (the x axis) of the P1 plane corresponds to a spatial frequency kₓ in the x direction of the P2 plane, and the vertical axis (the y axis) of the P1 plane corresponds to a spatial frequency k_{y} in the y direction of the P2 plane. The lens 33 inputs the light from the point image of the first split light L1 for each modulation frequency Ωₙ illustrated in FIG. 2, and can irradiate the observation object S along the irradiation direction according to the modulation frequency Ωₙ with the first split light L1 of each modulation frequency Ωₙ as a plane wave.

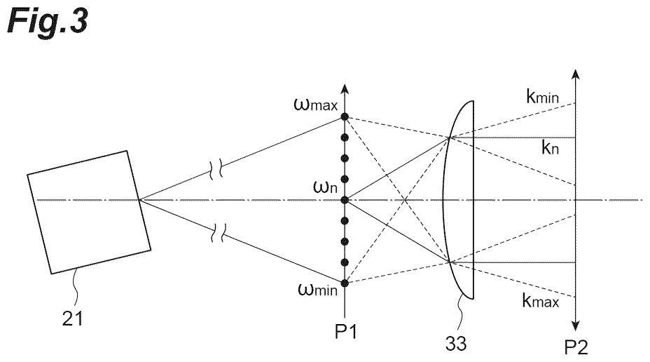

FIG. 3 is a diagram for describing the irradiation of the first split light on the observation object S by using the lens 33. This diagram indicates that a y component of a wavenumber vector is kₘᵢₙ in the case in which the first split light L1 of the optical frequency ωₘᵢₙ (=ω₀+Ω₁) modulated at the frequency Ω₁ is incident on the P2 plane as the plane wave, and indicates that a y component of a wavenumber vector is kₘₐₓ in the case in which the first split light L1 of the optical frequency ωₘₐₓ (=ω₀+Ω_{N}) modulated at the frequency Ω_{N} is incident on the P2 plane as the plane wave.

The lens 34 and the lens 35 constitute an imaging optical system for inputting the first split light L1 which is passed through the observation object S, and forming an image of the observation object S on an imaging plane (a P3 plane) of the imaging unit 23. The imaging plane (the P3 plane) has an optically conjugate relationship with respect to the plane (the P2 plane) including the moving path of the observation object S. For example, the lens 34 is an objective lens having a magnification of 60 times, and the lens 35 is an imaging lens having a focal length of 200 mm. The combining unit 15 is arranged on the optical path between the lens 34 and the lens 35.

The second modulation unit 22 applies a frequency difference between the first split light L1 and the second split light L2 (the second modulation step). The second modulation unit 22 is arranged on the optical path of the second split light L2. The second modulation unit 22 inputs the second split light L2, frequency modulates the second split light L2, and outputs the modulated light.

The second modulation unit 22 can have a configuration including, for example, an acousto-optic frequency shifter (AOFS, for example, model number 1250C manufactured by ISOMET), a function generator (for example, AFG3252C manufactured by Tektronics), and a high speed amplifier. In this case, a sinusoidal signal output from the function generator is amplified by the high speed amplifier with an amplification factor of, for example, +25 dB, and the sinusoidal signal which is made to be, for example, an amplitude 25 dBm by the amplification is given to the AOFS. By causing the second split light L2 to be incident on the AOFS described above, the second split light L2 can be modulated at the frequency Ω_{LO}.

In the case in which the diffracted light having the positive diffraction order (the diffracted light output in the same direction as the propagation direction of the acoustic wave) is used, the optical frequency ω_{LO} of the second split light L2 after the modulation becomes ω₀+Ω_{LO}. For example, it is set to Ω_{LO}=195 MHz.

The second modulation unit 22 is provided for adjusting an optical heterodyne frequency ΔΩₙ (an optical frequency difference between the first split light L1 and the second split light L2 at the time of the combining by the combining unit 15) to be equal to or less than one half of a sampling frequency Ω_{S} of the imaging unit 23. Therefore, in the case in which the modulation frequency Ωₙ of the first split light L1 is sufficiently small, and the optical heterodyne frequency ΔΩₙ is equal to or less than one half of the sampling frequency Ω_{S} of the imaging unit 23 even in the case of Ω_{LO}=0, the second modulation unit 22 may not be provided.

The lenses 36 to 38 constitute an optical system for causing the second split light L2 after the modulation by the second modulation unit 22 to be incident on the combining unit 15. Each of the lenses 36 and 37 is a spherical lens, and the lenses constitute a beam expander for expanding a beam diameter of the second split light L2. The lens 38 is a cylindrical lens. The lenses 36 to 38 focus the second split light L2 in a line shape on the imaging plane of the imaging unit 23 together with the lens 35.

The imaging unit 23 includes a plurality of pixels arranged one-dimensionally in a direction intersecting with the moving direction of the image of the observation object S by the first split light L1 on the imaging plane (the P3 plane) on which the image of the observation object S is formed. As the imaging unit 23, for example, a sensor such as a line sensor can be used. The second split light L2 is focused in the line shape along the plurality of pixels which are arranged one-dimensionally as described above. The imaging unit 23 receives the combined light by the plurality of pixels arranged one-dimensionally, and repeatedly outputs the detection signal representing the one-dimensional interference image.

It is preferable that the relationship represented by the following Formula (2) is satisfied by the lowest optical frequency ωₘᵢₙ (=ω₀+Ω₁) of the first split light L1 which is frequency modulated by the first modulation unit 21, the highest optical frequency ωₘₐₓ (=ω₀+Ω_{N}) of the first split light L1 which is frequency modulated by the first modulation unit 21, and the optical frequency ω_{LO} (=ω₀+Ω_{LO}) of the second split light L2 which is frequency modulated by the second modulation unit 22. ω₀ is the optical frequency of the light output from the light source 11. Further, it is preferable that the sampling frequency Ω_{S} of the imaging unit 23 satisfies the condition represented by the following Formula (3) or the following Formula (4).

### [Formula 2]

ω_{LO}<ωₘᵢₙ or ωₘₐₓ<ω_{LO} (2)

### [Formula 3]

when ω_{LO}<ωₘᵢₙ; Ω_{S}≥2|ωₘₐₓ−ω_{LO}| (3)

### [Formula 4]

(4)

In the case in which the maximum modulation frequency Ω_{N} of the first split light L1 is set to 205 MHz, and the modulation frequency Ω_{LO} of the second split light L2 is set to 195 MHz, the maximum value of the optical heterodyne frequency is 10 MHz, and thus, the sampling frequency Ω_{S} of the imaging unit 23 may be set to 20 MHz.

The processing unit 24 generates a complex amplitude image for each of the plurality of irradiation directions on the observation object S corresponding to the plurality of modulation frequencies based on the time series data of the one-dimensional interference image generated from the detection signal which is repeatedly output from the imaging unit 23.

The processing unit 24 is configured by using, for example, an operation device (a computer or the like) including built-in components of a central processing unit (CPU) or a graphics processing unit (GPU) which is a processor, a random access memory (RAM) or a read only memory (ROM) which is a storage medium, a communication module, an input and output module, and the like. Further, for example, the processing unit 24 may be configured by using a field programmable gate array (FPGA) or an application specific integrated circuit (ASIC).

In addition, the processing unit 24 generates a three-dimensional refractive index distribution image of the observation object S based on the complex amplitude image of each of the plurality of irradiation directions. Specifically, it is as follows.

The time series data of the one-dimensional interference image which is generated from the detection signal repeatedly output from the imaging unit 23 is represented by I(x, t). x is a variable representing a position (an x direction position) of each of the plurality of pixels arranged one-dimensionally on the imaging plane of the imaging unit 23. t is a variable representing a time at which the imaging unit 23 captures the one-dimensional interference image. The processing unit 24 performs Fourier transform on the time series data I(x, t) with respect to the time t. The result of the Fourier transform is represented by J(x, f). f is a variable representing a frequency.

The processing unit 24 extracts, from the data of J(x, f) described above, data of a frequency range (ΔΩₙ−BW/2<f<ΔΩₙ+BW/2) with a band width BW centered on the optical heterodyne frequency ΔΩₙ, and performs Fourier transform on the extracted data of the frequency range with respect to the frequency f. The result of the Fourier transform is represented by Iₙ(x, t). In this case, the observation object S is moved in the y direction, and thus, the variable t representing the time can be converted into a variable y representing a y direction position. Therefore, Iₙ(x, t) can be represented by Iₙ(x, y).

Iₙ(x, y) represents the two-dimensional complex amplitude image of the observation object S by the first split light LI arriving at the imaging plane of the imaging unit 23 in the case in which the observation object S is irradiated with the first split light L1 along the irradiation direction according to the optical heterodyne frequency ΔΩₙ (that is, the irradiation direction according to the modulation frequency Ωₙ). The processing unit 24 generates the complex amplitude image Iₙ(x, y) for the irradiation direction on the observation object S corresponding to each modulation frequency Ωₙ.

In addition, the processing unit 24 generates the three-dimensional refractive index distribution image of the observation object S based on the complex amplitude images I₁(x, y) to I_{N}(x, y) respectively for the plurality of irradiation directions. When the three-dimensional refractive index distribution image is generated based on the complex amplitude images I₁(x, y) to I_{N}(x, y), a method described in Non Patent Document 1 or Non Patent Document 2 can be used.

The method described in Non Patent Document 1 is a method using the Fourier slice theorem, and the method can be applied to the case in which scattering of light in the observation object S can be ignored. The method described in Non Patent Document 2 is a method using the Fourier diffraction theorem, and the method generates the three-dimensional refractive index distribution image of the observation object S in consideration of scattering of light in the observation object S.

As described above, the observation apparatus 1 can use a line sensor instead of an area sensor as the imaging unit 23, and thus, the line rate (the sampling frequency Ω_{S}) can be increased, and further, an inexpensive configuration can be achieved. In addition, the optical system from the observation object S to the imaging unit 23 can be set to a normal imaging optical system, and thus, the optical system can be easily adjusted, and the observation object S can be easily observed.

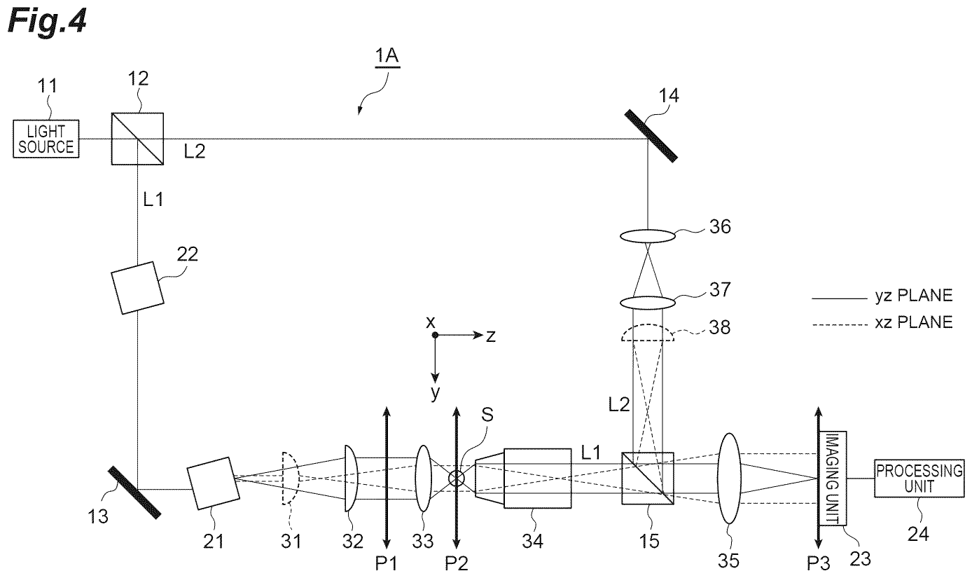

Next, modifications of the entire configuration of the observation apparatus 1 will be described with reference to FIG. 4 to FIG. 6.

An observation apparatus 1A of a first modification which is illustrated in FIG. 4 is different compared with the configuration of the observation apparatus 1 (FIG. 1) in the position at which the second modulation unit 22 is arranged. In the observation apparatus 1 (FIG. 1), the second modulation unit 22 is arranged on the optical path of the second split light L2. On the other hand, in the observation apparatus 1A (FIG. 4), the second modulation unit 22 is arranged on the optical path of the first split light L1 between the splitting unit 12 and the first modulation unit 21.

In the above configuration also, the second modulation unit 22 can adjust the optical heterodyne frequency ΔΩₙ (the optical frequency difference between the first split light L1 and the second split light L2 at the time of the combining by the combining unit 15) to be equal to or less than one half of the sampling frequency Ω_{S} of the imaging unit 23.

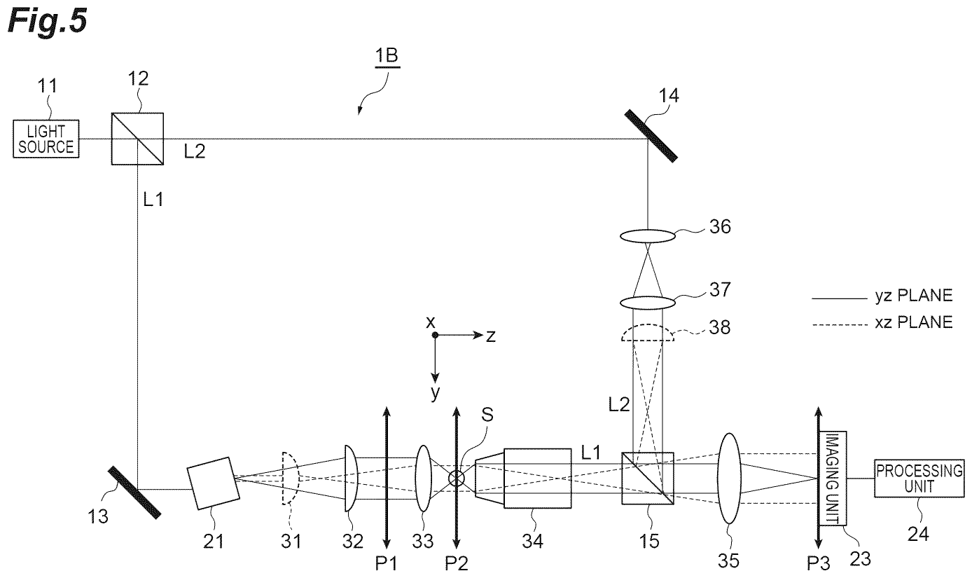

An observation apparatus 1B of a second modification which is illustrated in FIG. 5 is different compared with each of the configurations of the observation apparatus 1 (FIG. 1) and the observation apparatus 1A (FIG. 4) in that the second modulation unit 22 is not provided. As described above, in the case in which the modulation frequency Ωₙ of the first split light is sufficiently small, and the optical heterodyne frequency ΔΩₙ is equal to or less than one half of the sampling frequency Ω_{S} of the imaging unit 23 even in the case of Ω_{LO}=0, the second modulation unit 22 may not be provided.

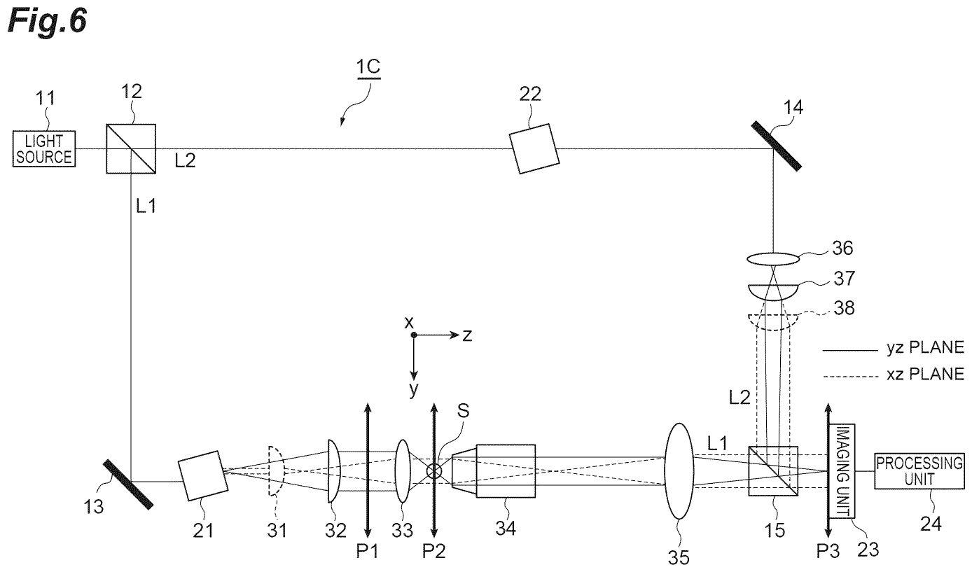

An observation apparatus 1C of a third modification which is illustrated in FIG. 6 is different compared with the configuration of the observation apparatus 1 (FIG. 1) in the arrangement of the combining unit 15, the lens 34, and the lens 35. In the observation apparatus 1 (FIG. 1), the combining unit 15 is arranged on the optical path between the lens 34 and the lens 35. On the other hand, in the observation apparatus 1C (FIG. 6), the combining unit 15 is arranged at a subsequent stage of the lens 35. Further, along with the above, in the observation apparatus 1C (FIG. 6), the lens 36 is a spherical lens, and each of the lenses 37 and 38 is a cylindrical lens.

In addition, in the observation apparatus 1C of the third modification illustrated in FIG. 6, the second modulation unit 22 may be arranged on the optical path of the first split light L1 between the splitting unit 12 and the first modulation unit 21, instead of on the optical path of the second split light L2. Further, in the observation apparatus 1C of the third modification illustrated in FIG. 6, in the case in which the modulation frequency Ωₙ of the first split light is sufficiently small, and the optical heterodyne frequency ΔΩₙ is equal to or less than one half of the sampling frequency Ω_{S} of the imaging unit 23 even in the case of Ω_{LO}=0, the second modulation unit 22 may not be provided.

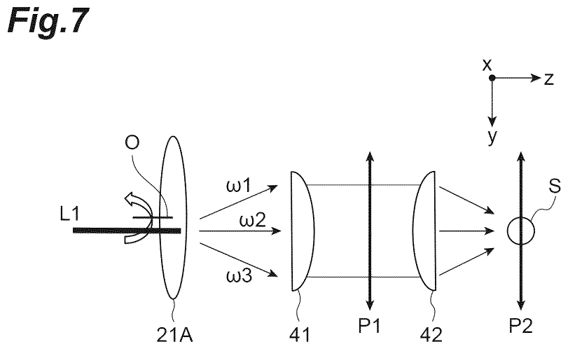

Next, configuration examples of the first modulation unit 21 will be described with reference to FIG. 7 to FIG. 12.

The first modulation unit 21 described above has the configuration including the acousto-optic element for frequency modulating the light by Bragg diffraction. In the above first modulation unit 21, by applying the RF signal including the plurality of frequency components different from each other to the acousto-optic element, and causing the first split light L1 to be incident on the acousto-optic element, the first split light L1 can be modulated at the modulation frequency corresponding to each frequency component of the RF signal. The first modulation unit 21 can output the first split light L1 which is modulated by each of the N frequency components Ω₁ to Ω_{N} in the directions different from each other.

A first modulation unit of a first modification may have a configuration including an acousto-optic element for frequency modulating the light by Raman-Nath diffraction. In this case, in the first modulation unit, by applying an RF signal of a single frequency (for example, 3 MHz) to the acousto-optic element, and causing the first split light L1 to be incident on the acousto-optic element, the first split light L1 can be modulated at each of the plurality of modulation frequencies different from each other according to the diffraction order.

The first modulation unit can output the first split light L1 which is modulated by each of the N frequency components Ω₁ to Ω_{N} in the directions different from each other according to the diffraction order. The optical system of the irradiation unit between the first modulation unit and the observation object S may have the same configuration as the configuration illustrated in FIG. 1.

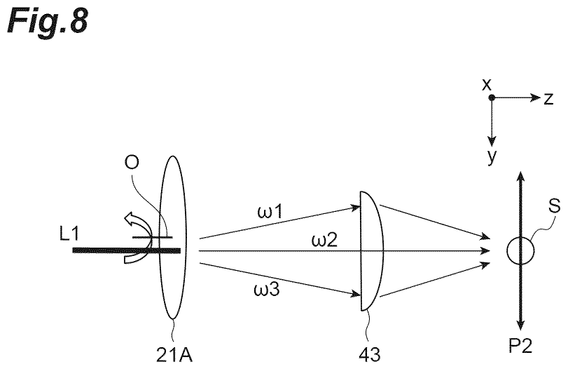

A first modulation unit 21A of a second modification which is illustrated in each of FIG. 7 and FIG. 8 has a configuration including a plate-shaped member on which diffraction gratings having a plurality of spatial frequency components different from each other are superimposed and recorded. The plate-shaped member of the first modulation unit 21A illustrated in these diagrams has a circular shape parallel to the xy plane, is rotatable around a center axis O parallel to the z direction, and the diffraction gratings having the plurality of spatial frequency components are superimposed and recorded along a circumferential direction.

The first modulation unit 21A rotates the plate-shaped member around the center axis at a constant speed, and further, transmits the first split light L1 through the plate-shaped member. In this case, the first split light L1 is set to be incident on a position substantially within the xz plane including the center axis O of the rotation of the plate-shaped member, and the plate-shaped member is moved in the y direction at the incident position. By using the above configuration, the first split light L1 can be modulated at each of the plurality of modulation frequencies different from each other.

In the configuration illustrated in FIG. 7, the optical system of the irradiation unit between the first modulation unit 21A and the observation object S includes two cylindrical lenses 41 and 42. In the configuration illustrated in FIG. 8, the optical system of the irradiation unit between the first modulation unit 21A and the observation object S includes one cylindrical lens 43. In any of the above cases, the irradiation unit irradiates the observation object S along the irradiation direction according to the modulation frequency Ωₙ with the first split light L1 which is modulated by the first modulation unit 21A.

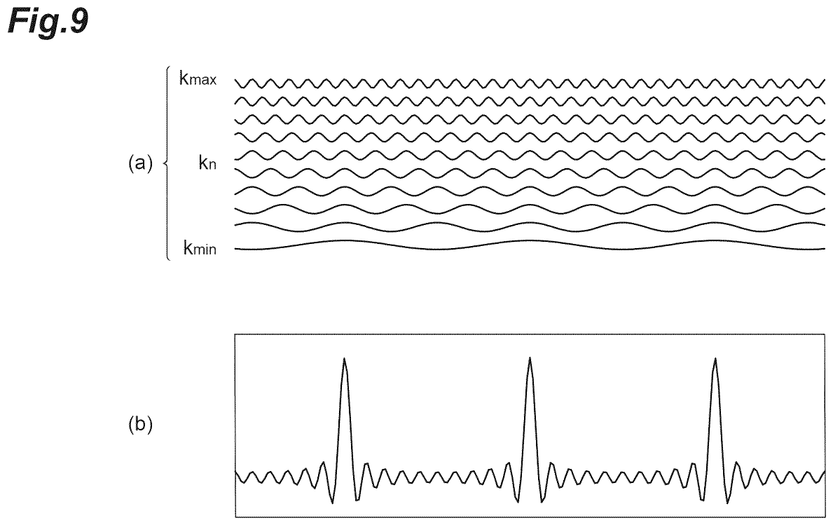

FIG. 9 includes diagrams for describing the diffraction grating which is recorded on the plate-shaped member of the first modulation unit 21A of the second modification. In this diagram, the horizontal axis indicates a position in the circumferential direction, and the vertical axis indicates a modulation amount. (a) in FIG. 9 illustrates the modulation distribution of each of the diffraction gratings having the plurality of spatial frequency components kₙ (kₘᵢₙ to kₘₐₓ). (b) in FIG. 9 illustrates the modulation distribution after the diffraction gratings having the plurality of spatial frequency components are superimposed.

The plate-shaped member of the first modulation unit 21A illustrated in each of FIG. 7 and FIG. 8 has the circular shape, and further, the plate-shaped member on which the diffraction gratings having the plurality of spatial frequency components different from each other are superimposed and recorded may have a band shape. In this case, the plate-shaped member of the band shape of the first modulation unit 21A is movable in the y direction, and the diffraction gratings having the plurality of spatial frequency components are superimposed and recorded along a moving direction.

In the first modulation unit 21A, by moving the plate-shaped member of the band shape in the y direction, and causing the first split light L1 to be transmitted through the plate-shaped member, the first split light L1 can be modulated at each of the plurality of modulation frequencies different from each other. In the case in which both ends of the plate-shaped member of the band shape are connected to each other to form a ring shape, and the plate-shaped member having the ring shape is rotated, the plate-shaped member can be moved in the y direction for a long time.

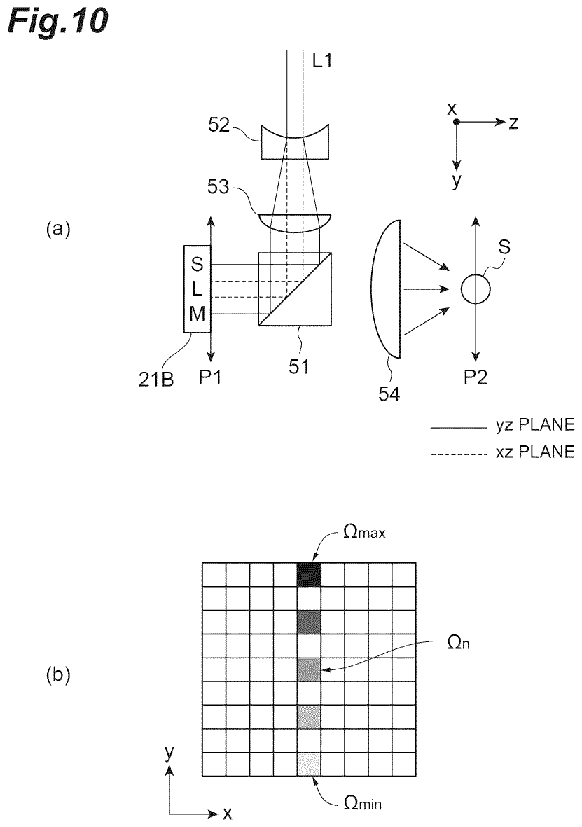

A first modulation unit 21B of a third modification which is illustrated in FIG. 10 has a configuration including a spatial light modulator (SLM) of a phase modulation type. In this diagram, the spatial light modulator of a reflection type is illustrated. (a) in FIG. 10 illustrates a configuration of the first modulation unit 21B and the surrounding optical system. (b) in FIG. 10 illustrates the modulation frequency in each region on a modulation plane of the spatial light modulator of the first modulation unit 21B by grayscale.

In the spatial light modulator of the first modulation unit 21B, in a region out of the modulation plane (the P1 plane) which has a limited width in the x direction, a phase modulation amount is changed at speeds different from each other respectively in a plurality of regions divided along the y direction. That is, the phase modulation amount φ in each region is temporally continuously changed with a relationship of φ=Ωₙt with respect to the time t.

The first split light L1, which is passed through cylindrical lenses 52 and 53, is reflected by a beam splitter 51, and is incident on the modulation plane of the spatial light modulator. The cylindrical lens 52 is a concave lens, and the cylindrical lens 53 is a convex lens.

By causing the first split light L1 to be incident on the region extending in the y direction (the region having the limited width in the x direction) out of the modulation plane of the spatial light modulator, the first split light L1 can be modulated at the modulation frequency Ωₙ in each region along the y direction on the modulation plane of the spatial light modulator.

The first split light L1, which is modulated as described above, is transmitted through the beam splitter 51, and then the observation object S is irradiated with the first split light LI along the irradiation direction according to the modulation frequency Ωₙ by a cylindrical lens 54. In addition, the light reflected by the modulation plane in which the phase modulation amount is not temporally continuously changed is prevented from being incident on the observation object S by using a mask or the like (not illustrated).

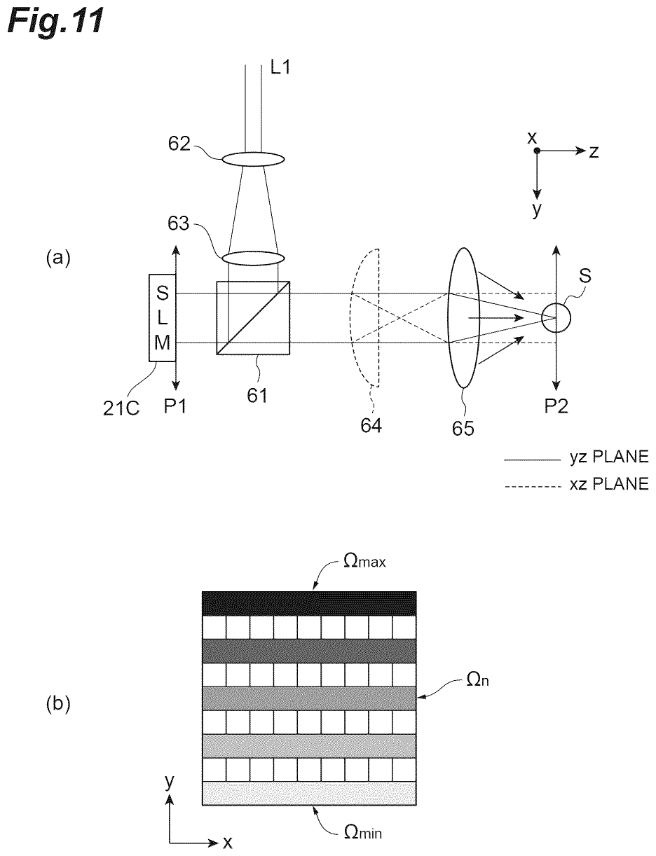

A first modulation unit 21C of a fourth modification which is illustrated in FIG. 11 also has a configuration including the spatial light modulator (SLM) of the phase modulation type. In this diagram also, the spatial light modulator of the reflection type is illustrated. (a) in FIG. 11 illustrates a configuration of the first modulation unit 21C and the surrounding optical system. (b) in FIG. 11 illustrates the modulation frequency in each region on the modulation plane of the spatial light modulator of the first modulation unit 21C by grayscale.

In the spatial light modulator of the first modulation unit 21C, in the entire region in the x direction of the modulation plane (the P1 plane), the phase modulation amount is changed at speeds different from each other respectively in the plurality of regions divided along the y direction. That is, the phase modulation amount φ in each region is temporally continuously changed with a relationship of φ=Ωₙt with respect to the time t.

The first split light, having the beam diameter which is expanded by lenses 62 and 63, is reflected by a beam splitter 61, and is incident on substantially the entire modulation plane of the spatial light modulator. By causing the first split light LI to be incident on substantially the entire modulation plane of the spatial light modulator, the first split light L1 can be modulated at the modulation frequency Ωₙ in each region along the y direction on the modulation plane of the spatial light modulator.

The first split light L1, which is modulated as described above, is transmitted through the beam splitter 61, and then the observation object S is irradiated with the first split light L1 along the irradiation direction according to the modulation frequency Ωₙ by lenses 64 and 65. In addition, the light reflected by the modulation plane in which the phase modulation amount is not temporally continuously changed is prevented from being incident on the observation object S by using a mask or the like (not illustrated).

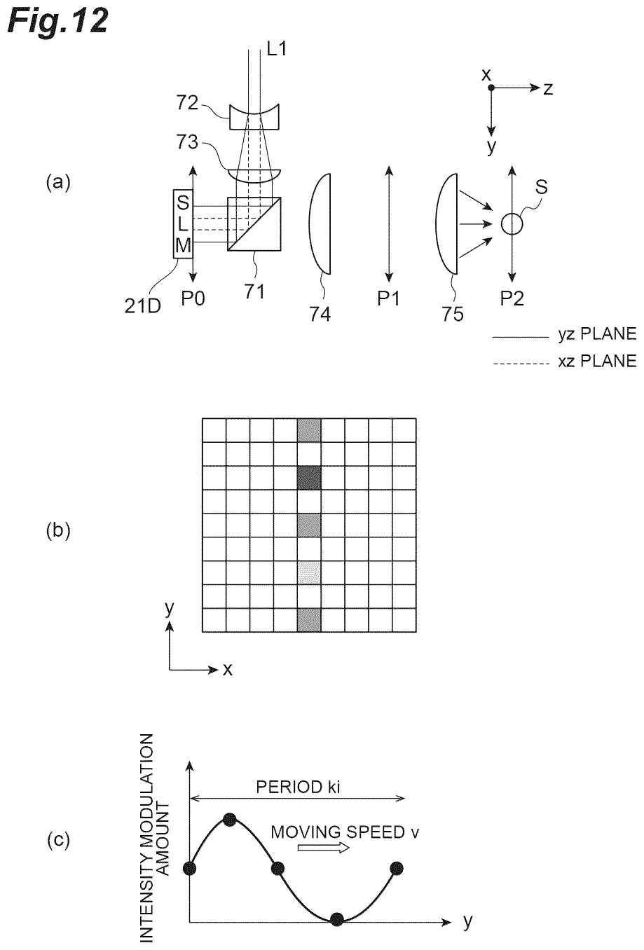

A first modulation unit 21D of a fifth modification which is illustrated in FIG. 12 has a configuration including the spatial light modulator (SLM) of an intensity modulation type. In this diagram also, the spatial light modulator of the reflection type is illustrated. (a) in FIG. 12 illustrates a configuration of the first modulation unit 21D and the surrounding optical system. (b) in FIG. 12 illustrates an intensity modulation amount in each region on the modulation plane of the spatial light modulator of the first modulation unit 21D by grayscale. (c) in FIG. 12 is a graph showing the intensity modulation amount in each region along the y direction on the modulation plane of the spatial light modulator of the first modulation unit 21D.

In the spatial light modulator of the first modulation unit 21D, in a region out of the modulation plane (a P0 plane) which has a limited width in the x direction, the intensity modulation amount is set in each of the plurality of regions divided along the y direction, and the y direction distribution of the intensity modulation amount is moved in the y direction. In the case in which the intensity modulation amount distribution has a sinusoidal shape with a period of ki and the moving speed in the y direction is set to V, a phase shift is generated by exp(ikᵢVt) on a Fourier plane (the P1 plane) with respect to the modulation plane (the P0 plane), and the frequency modulation of Ω=kᵢV is generated. The above fact is used in the fifth modification.

The intensity modulation amount distribution along the y direction on the modulation plane of the spatial light modulator is set to include a plurality of spatial frequency components different from each other, and the intensity modulation amount distribution is moved at a constant speed in the y direction on the modulation plane of the spatial light modulator.

The first split light L1, which is passed through cylindrical lenses 72 and 73, is reflected by a beam splitter 71, and is incident on the modulation plane of the spatial light modulator. The cylindrical lens 72 is a concave lens, and the cylindrical lens 73 is a convex lens.

A front focal plane of a cylindrical lens 74 is the modulation plane (the PO plane) of the spatial light modulator, and further, a rear focal plane of the cylindrical lens 74 is the P1 plane. A front focal plane of a cylindrical lens 75 is the P1 plane, and further, a rear focal plane of the cylindrical lens 75 is the plane (the P2 plane) including the moving path of the observation object S.

By causing the first split light LI to be incident on the region extending in the y direction (the region having the limited width in the x direction) out of the modulation plane (the P0 plane) of the spatial light modulator, similar to the case of FIG. 2, the point image of the first split light L1, which is modulated at the modulation frequency Ωₙ, can be formed in each region along the y direction on the P1 plane. In addition, the lens 75 inputs the light from the point image of the first split light L1 for each modulation frequency Ωₙ on the P1 plane, and can irradiate the observation object S along the irradiation direction according to the modulation frequency Ωₙ with the first split light L1 of each modulation frequency Ωₙ as a plane wave.

In addition, each of the first modulation units 21B to 21D according to the third to fifth modifications has a configuration including the spatial light modulator of the reflection type, and further, it may have a configuration including a spatial light modulator of a transmission type. Further, a digital mirror device (DMD) may be used as a spatial light modulator of a reflection type and an intensity modulation type, and in this case, multiple stage intensity modulation can be applied to the light by using pulse width modulation (PWM).

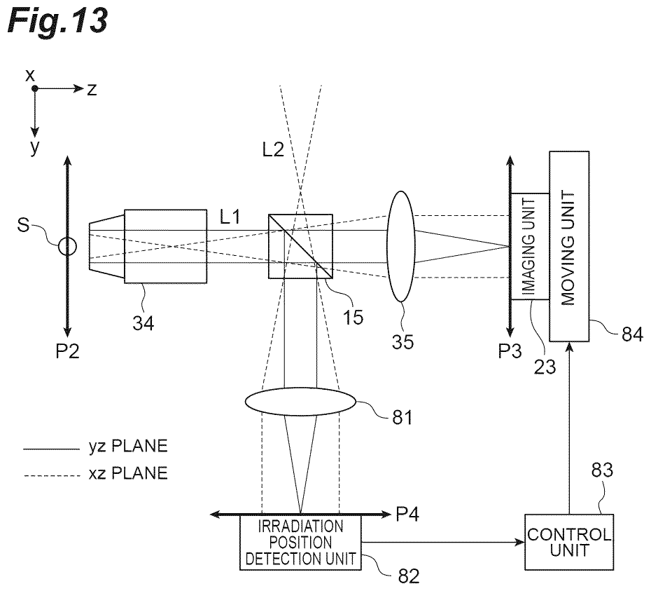

Next, a modification of the configuration around the imaging unit 23 will be described with reference to FIG. 13. In the configuration of the modification illustrated in this diagram, a lens 81, an irradiation position detection unit 82, a control unit 83, and a moving unit 84 are further provided. The combining unit 15 arranged on the optical path between the lens 34 and the lens 35 combines the first split light L1 and the second split light L2, outputs the combined light to the lens 35, and in addition, outputs the combined light also to the lens 81.

The lens 81 is arranged on the optical path of the combined light between the combining unit 15 and the irradiation position detection unit 82. The lens 34 and the lens 81 constitute an imaging optical system for inputting the first split light L1 which is passed through the observation object S, and forming an image of the observation object S on an imaging plane (a P4 plane) of the irradiation position detection unit 82. The irradiation position detection unit 82 is a unit for detecting an irradiation position of the first split light L1 on the moving path of the observation object S, and is, for example, an area camera capable of capturing a two-dimensional image. The area camera in this case does not need to be capable of high speed imaging.

The control unit 83 drives the moving unit 84 based on the irradiation position detected by the irradiation position detection unit 82, and thus, the y direction position of the imaging unit 23 is controlled such that the combined light can be received by the plurality of pixels arranged one-dimensionally of the imaging unit 23. The moving unit 84 is a unit for moving the imaging unit 23 in the moving direction (the y direction) of the image of the observation object S on the imaging plane (the P3 plane) of the imaging unit 23 according to the drive by the control unit 83, and is, for example, a uniaxial stage with an electric actuator.

By using the above configuration, even in the case in which the irradiation position of the first split light L1 on the moving path of the observation object S temporally drifts in the y direction, the incident position of the first split light LI on the imaging plane (the P3 plane) of the imaging unit 23 can be fixed, and thus, the imaging unit 23 can constantly and stably acquire the one-dimensional interference image.

In addition, in order to stably receive the combined light by the plurality of pixels arranged one-dimensionally in the imaging unit 23, in addition to or instead of controlling the y direction position of the imaging unit 23, the optical system from the observation object S to the imaging unit 23 may be controlled. In the latter case, for example, a mirror in which an orientation of a reflection surface is variable may be arranged in the middle of the optical system from the observation object S to the imaging unit 23, and the orientation of the reflection surface of the mirror may be controlled by the control unit 83.

Further, the irradiation position detection unit 82 only needs to be able to detect the irradiation position of the first split light L1 on the moving path of the observation object S, and thus, the irradiation position detection unit 82 may receive only the first split light L1 without receiving the combined light. For example, in the configuration illustrated in FIG. 6, a beam splitter may be arranged between the lens 34 and the lens 35, and an image of the observation object S by the first split light L1 which is split by the beam splitter may be formed on the imaging plane (the P4 plane) of the irradiation position detection unit 82 by the lens 81.

Further, as the irradiation position detection unit 82, a profile sensor with a center-of-gravity calculation circuit for incident position detection of spot light (for example, S15366-512 manufactured by Hamamatsu Photonics K.K.) may be used, and further, a position sensitive detector (PSD, for example, S2044 manufactured by Hamamatsu Photonics K.K.) may be used.

The observation apparatus and the observation method are not limited to the embodiments and configuration examples described above, and various modifications are possible.

The observation apparatus of a first aspect according to the above embodiment is an apparatus for observing a moving observation object, and includes (1) a light source for outputting light; (2) a splitting unit for splitting the light into first split light and second split light; (3) a first modulation unit for modulating the first split light at each of a plurality of modulation frequencies different from each other; (4) an irradiation unit for irradiating the observation object along an irradiation direction according to the modulation frequency with the first split light modulated by the first modulation unit; (5) a combining unit for combining the first split light passed through the observation object and the second split light to output combined light; (6) an imaging unit including a plurality of pixels arranged in a direction intersecting with a moving direction of an image of the observation object on an imaging plane on which the image of the observation object is formed, and for receiving the combined light by the plurality of pixels, and repeatedly outputting a detection signal representing a one-dimensional interference image; and (7) a processing unit for generating a complex amplitude image for each of a plurality of irradiation directions on the observation object corresponding to the plurality of modulation frequencies based on time series data of the one-dimensional interference image generated from the detection signal repeatedly output from the imaging unit, and generating a three-dimensional refractive index distribution image of the observation object based on the complex amplitude image of each of the plurality of irradiation directions.

In the observation apparatus of a second aspect, in the configuration of the first aspect, the apparatus may further include a second modulation unit provided on an optical path of the first split light between the splitting unit and the first modulation unit or on an optical path of the second split light between the splitting unit and the combining unit, and for applying a frequency difference between the first split light and the second split light.

In the observation apparatus of a third aspect, in the configuration of the first or second aspect, the first modulation unit may include an acousto-optic element for frequency modulating light by Bragg diffraction, may apply an RF signal including a plurality of frequency components different from each other to the acousto-optic element, may cause the first split light to be incident on the acousto-optic element, and may modulate the first split light at the modulation frequency according to each frequency component of the RF signal.

In the observation apparatus of a fourth aspect, in the configuration of the first or second aspect, the first modulation unit may include an acousto-optic element for frequency modulating light by Raman-Nath diffraction, may apply an RF signal of a single frequency to the acousto-optic element, may cause the first split light to be incident on the acousto-optic element, and may modulate the first split light at each of the plurality of modulation frequencies different from each other.

In the observation apparatus of a fifth aspect, in the configuration of the first or second aspect, the first modulation unit may include a plate-shaped member on which diffraction gratings having a plurality of spatial frequency components different from each other are superimposed and recorded, may move the plate-shaped member, may cause the first split light to be transmitted through the plate-shaped member, and may modulate the first split light at each of the plurality of modulation frequencies different from each other.

In the observation apparatus of a sixth aspect, in the configuration of the first or second aspect, the first modulation unit may include a spatial light modulator of a phase modulation type, may change a phase modulation amount at different speeds according to regions on a modulation plane of the spatial light modulator, may cause the first split light to be incident on the modulation plane of the spatial light modulator, and may modulate the first split light at the modulation frequency according to a speed of a change of the phase modulation amount in each region on the modulation plane of the spatial light modulator.

In the observation apparatus of a seventh aspect, in the configuration of the first or second aspect, the first modulation unit may include a spatial light modulator of an intensity modulation type, may set an intensity modulation amount distribution along a predetermined direction on a modulation plane of the spatial light modulator to include a plurality of spatial frequency components different from each other, may move the intensity modulation amount distribution in the predetermined direction on the modulation plane of the spatial light modulator, may cause the first split light to be incident on the modulation plane of the spatial light modulator, and may modulate the first split light at each of the plurality of modulation frequencies different from each other.

In the observation apparatus of an eighth aspect, in the configuration of any one of the first to seventh aspects, the apparatus may further include an irradiation position detection unit for detecting an irradiation position of the first split light on a moving path of the observation object; and a control unit for controlling an optical system from the observation object to the imaging unit or a position of the imaging unit such that the combined light is received by the plurality of pixels of the imaging unit based on the irradiation position detected by the irradiation position detection unit.

The observation method of a first aspect according to the above embodiment is a method for observing a moving observation object, and includes (1) a splitting step of splitting light output from a light source into first split light and second split light by using a splitting unit; (2) a first modulation step of modulating the first split light at each of a plurality of modulation frequencies different from each other by using a first modulation unit; (3) an irradiation step of irradiating the observation object along an irradiation direction according to the modulation frequency with the first split light modulated by the first modulation unit; (4) a combining step of combining the first split light passed through the observation object and the second split light to output combined light by using a combining unit; (5) an imaging step of using an imaging unit including a plurality of pixels arranged in a direction intersecting with a moving direction of an image of the observation object on an imaging plane on which the image of the observation object is formed, receiving the combined light by the plurality of pixels, and repeatedly outputting a detection signal representing a one-dimensional interference image; and (6) a processing step of generating a complex amplitude image for each of a plurality of irradiation directions on the observation object corresponding to the plurality of modulation frequencies based on time series data of the one-dimensional interference image generated from the detection signal repeatedly output from the imaging unit, and generating a three-dimensional refractive index distribution image of the observation object based on the complex amplitude image of each of the plurality of irradiation directions.

In the observation method of a second aspect, in the configuration of the first aspect, the method may further include a second modulation step of using a second modulation unit provided on an optical path of the first split light between the splitting unit and the first modulation unit or on an optical path of the second split light between the splitting unit and the combining unit, and applying a frequency difference between the first split light and the second split light.

In the observation method of a third aspect, in the configuration of the first or second aspect, in the first modulation step, the first modulation unit including an acousto-optic element for frequency modulating light by Bragg diffraction may be used, an RF signal including a plurality of frequency components different from each other may be applied to the acousto-optic element, the first split light may be caused to be incident on the acousto-optic element, and the first split light may be modulated at the modulation frequency according to each frequency component of the RF signal.

In the observation method of a fourth aspect, in the configuration of the first or second aspect, in the first modulation step, the first modulation unit including an acousto-optic element for frequency modulating light by Raman-Nath diffraction may be used, an RF signal of a single frequency may be applied to the acousto-optic element, the first split light may be caused to be incident on the acousto-optic element, and the first split light may be modulated at each of the plurality of modulation frequencies different from each other.

In the observation method of a fifth aspect, in the configuration of the first or second aspect, in the first modulation step, the first modulation unit including a plate-shaped member on which diffraction gratings having a plurality of spatial frequency components different from each other are superimposed and recorded may be used, the plate-shaped member may be moved, the first split light may be caused to be transmitted through the plate-shaped member, and the first split light may be modulated at each of the plurality of modulation frequencies different from each other.

In the observation method of a sixth aspect, in the configuration of the first or second aspect, in the first modulation step, the first modulation unit including a spatial light modulator of a phase modulation type may be used, a phase modulation amount may be changed at different speeds according to regions on a modulation plane of the spatial light modulator, the first split light may be caused to be incident on the modulation plane of the spatial light modulator, and the first split light may be modulated at the modulation frequency according to a speed of a change of the phase modulation amount in each region on the modulation plane of the spatial light modulator.

In the observation method of a seventh aspect, in the configuration of the first or second aspect, in the first modulation step, the first modulation unit including a spatial light modulator of an intensity modulation type may be used, an intensity modulation amount distribution along a predetermined direction on a modulation plane of the spatial light modulator may be set to include a plurality of spatial frequency components different from each other, the intensity modulation amount distribution may be moved in the predetermined direction on the modulation plane of the spatial light modulator, the first split light may be caused to be incident on the modulation plane of the spatial light modulator, and the first split light may be modulated at each of the plurality of modulation frequencies different from each other.

In the observation method of an eighth aspect, in the configuration of any one of the first to seventh aspects, the method may further include detecting an irradiation position of the first split light on a moving path of the observation object; and controlling an optical system from the observation object to the imaging unit or a position of the imaging unit such that the combined light is received by the plurality of pixels of the imaging unit based on the detected irradiation position.

### Industrial Applicability

The embodiments can be used as an apparatus and a method capable of easily observing a moving observation object with an inexpensive configuration.

### REFERENCE SIGNS LIST

1, 1A-1C—observation apparatus, 11—light source, 12—splitting unit, 13, 14—mirror, 15—combining unit, 21, 21A-21D—first modulation unit, 22—second modulation unit, 23—imaging unit, 24—processing unit, 31-38—lens, 82—irradiation position detection unit, 83—control unit, 84—moving unit.

1. An observation apparatus for observing a moving observation object, the apparatus comprising:
a light source configured to output light;
a splitting unit configured to split the light into first split light and second split light;
a first modulation unit configured to modulate the first split light at each of a plurality of modulation frequencies different from each other;
an irradiation unit configured to irradiate the observation object along an irradiation direction according to the modulation frequency with the first split light modulated by the first modulation unit;
a combining unit configured to combine the first split light passed through the observation object and the second split light to output combined light;
an imaging unit including a plurality of pixels arranged in a direction intersecting with a moving direction of an image of the observation object on an imaging plane on which the image of the observation object is formed, and configured to receive the combined light by the plurality of pixels, and repeatedly output a detection signal representing a one-dimensional interference image; and
a processing unit configured to generate a complex amplitude image for each of a plurality of irradiation directions on the observation object corresponding to the plurality of modulation frequencies based on time series data of the one-dimensional interference image generated from the detection signal repeatedly output from the imaging unit, and generate a three-dimensional refractive index distribution image of the observation object based on the complex amplitude image of each of the plurality of irradiation directions.

2. The observation apparatus according to claim 1, further comprising a second modulation unit provided on an optical path of the first split light between the splitting unit and the first modulation unit or on an optical path of the second split light between the splitting unit and the combining unit, and configured to apply a frequency difference between the first split light and the second split light.

3. The observation apparatus according to claim 1, wherein the first modulation unit includes an acousto-optic element configured to frequency modulate light by Bragg diffraction, applies an RF signal including a plurality of frequency components different from each other to the acousto-optic element, causes the first split light to be incident on the acousto-optic element, and modulates the first split light at the modulation frequency according to each frequency component of the RF signal.

4. The observation apparatus according to claim 1, wherein the first modulation unit includes an acousto-optic element configured to frequency modulate light by Raman-Nath diffraction, applies an RF signal of a single frequency to the acousto-optic element, causes the first split light to be incident on the acousto-optic element, and modulates the first split light at each of the plurality of modulation frequencies different from each other.

5. The observation apparatus according to claim 1, wherein the first modulation unit includes a plate-shaped member on which diffraction gratings having a plurality of spatial frequency components different from each other are superimposed and recorded, moves the plate-shaped member, causes the first split light to be transmitted through the plate-shaped member, and modulates the first split light at each of the plurality of modulation frequencies different from each other.

6. The observation apparatus according to claim 1, wherein the first modulation unit includes a spatial light modulator of a phase modulation type, changes a phase modulation amount at different speeds according to regions on a modulation plane of the spatial light modulator, causes the first split light to be incident on the modulation plane of the spatial light modulator, and modulates the first split light at the modulation frequency according to a speed of a change of the phase modulation amount in each region on the modulation plane of the spatial light modulator.

7. The observation apparatus according to claim 1, wherein the first modulation unit includes a spatial light modulator of an intensity modulation type, sets an intensity modulation amount distribution along a predetermined direction on a modulation plane of the spatial light modulator to include a plurality of spatial frequency components different from each other, moves the intensity modulation amount distribution in the predetermined direction on the modulation plane of the spatial light modulator, causes the first split light to be incident on the modulation plane of the spatial light modulator, and modulates the first split light at each of the plurality of modulation frequencies different from each other.

8. The observation apparatus according to claim 1, further comprising:
an irradiation position detection unit configured to detect an irradiation position of the first split light on a moving path of the observation object; and
a control unit configured to control an optical system from the observation object to the imaging unit or a position of the imaging unit such that the combined light is received by the plurality of pixels of the imaging unit based on the irradiation position detected by the irradiation position detection unit.

9. An observation method for observing a moving observation object, the method comprising:
performing a splitting of splitting light output from a light source into first split light and second split light by using a splitting unit;
performing a first modulation of modulating the first split light at each of a plurality of modulation frequencies different from each other by using a first modulation unit;
performing an irradiation of irradiating the observation object along an irradiation direction according to the modulation frequency with the first split light modulated by the first modulation unit;
performing a combining of combining the first split light passed through the observation object and the second split light to output combined light by using a combining unit;
performing an imaging of using an imaging unit including a plurality of pixels arranged in a direction intersecting with a moving direction of an image of the observation object on an imaging plane on which the image of the observation object is formed, receiving the combined light by the plurality of pixels, and repeatedly outputting a detection signal representing a one-dimensional interference image; and
performing a processing of generating a complex amplitude image for each of a plurality of irradiation directions on the observation object corresponding to the plurality of modulation frequencies based on time series data of the one-dimensional interference image generated from the detection signal repeatedly output from the imaging unit, and generating a three-dimensional refractive index distribution image of the observation object based on the complex amplitude image of each of the plurality of irradiation directions.

10. The observation method according to claim 9, further comprising performing a second modulation of using a second modulation unit provided on an optical path of the first split light between the splitting unit and the first modulation unit or on an optical path of the second split light between the splitting unit and the combining unit, and applying a frequency difference between the first split light and the second split light.

11. The observation method according to claim 9, wherein in the first modulation, the first modulation unit including an acousto-optic element configured to frequency modulate light by Bragg diffraction is used, an RF signal including a plurality of frequency components different from each other is applied to the acousto-optic element, the first split light is caused to be incident on the acousto-optic element, and the first split light is modulated at the modulation frequency according to each frequency component of the RF signal.

12. The observation method according to claim 9, wherein in the first modulation, the first modulation unit including an acousto-optic element configured to frequency modulate light by Raman-Nath diffraction is used, an RF signal of a single frequency is applied to the acousto-optic element, the first split light is caused to be incident on the acousto-optic element, and the first split light is modulated at each of the plurality of modulation frequencies different from each other.

13. The observation method according to claim 9, wherein in the first modulation, the first modulation unit including a plate-shaped member on which diffraction gratings having a plurality of spatial frequency components different from each other are superimposed and recorded is used, the plate-shaped member is moved, the first split light is caused to be transmitted through the plate-shaped member, and the first split light is modulated at each of the plurality of modulation frequencies different from each other.

14. The observation method according to claim 9, wherein in the first modulation, the first modulation unit including a spatial light modulator of a phase modulation type is used, a phase modulation amount is changed at different speeds according to regions on a modulation plane of the spatial light modulator, the first split light is caused to be incident on the modulation plane of the spatial light modulator, and the first split light is modulated at the modulation frequency according to a speed of a change of the phase modulation amount in each region on the modulation plane of the spatial light modulator.

15. The observation method according to claim 9, wherein in the first modulation, the first modulation unit including a spatial light modulator of an intensity modulation type is used, an intensity modulation amount distribution along a predetermined direction on a modulation plane of the spatial light modulator is set to include a plurality of spatial frequency components different from each other, the intensity modulation amount distribution is moved in the predetermined direction on the modulation plane of the spatial light modulator, the first split light is caused to be incident on the modulation plane of the spatial light modulator, and the first split light is modulated at each of the plurality of modulation frequencies different from each other.

16. The observation method according to claim 9, further comprising:
detecting an irradiation position of the first split light on a moving path of the observation object; and
controlling an optical system from the observation object to the imaging unit or a position of the imaging unit such that the combined light is received by the plurality of pixels of the imaging unit based on the detected irradiation position.
